(19) United States
(12) Patent Application Publication
(10) Pub. No.: US 2017/0004237 A1
(43) Pub. Date: Jan. 5, 2017

(54) SIMULATION METHOD AND SIMULATION APPARATUS

(71) Applicant: CANON KABUSHIKI KAISHA, Tokyo (JP)

(72) Inventor: Hironobu Sasaki, Yokohama-shi (JP)

(21) Appl. No.: 15/193,543

(22) Filed: Jun. 27, 2016

(30) Foreign Application Priority Data
Jul. 2, 2015 (JP) 2015-133451

(51) Int. Cl. G06F 17/50

(52) U.S. Cl. CPC G06F 17/5018; G06F 17/5086

(57) ABSTRACT

The orientation of an arbitrary point set to a part after deformation of the part can be calculated, which can execute more accurate analysis. The calculating apparatus sets the shape of a part, sets a mesh by setting a plurality of nodes on the part, and sets the position and orientation of the part. The apparatus sets an arbitrary point having an arbitrary position and orientation, on the part, and further sets at least two subsidiary points and at different positions in different directions, with respect to the arbitrary point, on the part. The apparatus executes calculation of deforming the part, calculates the position of the arbitrary point and the positions of the subsidiary points after deformation of the part, and calculates the orientation of the arbitrary point from the position of the arbitrary point and the positions of the subsidiary points after deformation of the part.

### BACKGROUND OF THE INVENTION

Field of the Invention

The present invention relates to a simulation method and a simulation apparatus for executing a simulation that deform parts using a three dimensional finite element method.

Description of the Related Art

In recent years, a simulation of part deformation in consideration of the gravitation and external forces applied to parts using a finite element method, has been performed. The finite element methods may be a one dimensional finite element method that performs calculation using beam elements, a two dimensional finite element method that performs calculation using shell elements, and a three dimensional finite element method that performs calculation using solid elements. For example, the one dimensional finite element method is suitable for a case of calculating the deformation of a rod-shaped member. For example, the two dimensional finite element method is suitable for a case of calculating the deformation of a plate-shaped member. The three dimensional finite element method is suitable for a case of calculating the deformation of a member having a complex three dimensional shape. For example, in a case of a multi-joint robot for assembling precision parts, replacement of the parts with one or two dimensional elements cannot achieve favorable accuracy. Consequently, a simulation that deforms parts using the three dimensional finite element method is appropriate.

For example, in the case of a multi-joint robot, the applied load force varies according to the angle of each joint. Consequently, the deformation according to movement can be obtained through a simulation, and the multi-joint robot can be accurately analyzed. A result of the simulation can be used to be reflected in calculation of the trajectory of the multi-joint robot and calculation of a drive instruction, and to identify whether interference with another object occurs or not. For example, in the case of performing a simulation of part deformation using the three dimensional finite element method in a multi-joint robot, a junction point between frames at each joint is set, and the position of the junction point after part deformation is obtained. An observation point for observing the position of the distal end of a hand is set, and the position of the observation point after part deformation is obtained. Thus, the position of the junction point of each joint, and the position of the observation point of the distal end of the hand are obtained, thereby allowing the accurate position of the multi-joint robot after part deformation to be obtained.

The three dimensional finite element method sets nodes to parts to thereby set, for example, meshes with solid elements, such as tetrahedrons, pentahedrons and hexahedrons. In this case, through setting, as the nodes, the points whose positions are required to be obtained, such as the junction points and observation points, the positions of the junction points and observation points after part deformation are obtained from the positions of the nodes having been subjected to a part deforming calculation. However, when these junction points and the observation points are set, it is appropriate that these junction points and observation points can be set on freely selected positions on parts. To set these junction points and observation points as nodes, an operation of increasing nodes and resetting the meshes is required.

Thus, a technique has been proposed that calculates a joint position (i.e., the positions of junction points) after part deformation in a mechanical system using a shape function (see Japanese Patent Application Laid-Open No. H6-34012). The shape function is a function representing the relationship between the displacement of a joint position and the displacement of a node due to the deformation of a part. Such representation of the relationship between the node position and the joint position in the shape function that is a constraint condition expression can omit the operation of increasing the nodes and resetting the meshes. The representation also has an advantage that distributes a force applied to a joint to the corresponding nodes and the force tends not to concentrate on one node.

The calculation scheme of the three dimensional finite element method only calculates the translational three degrees of freedom, and has no constraint in a rotational direction, when the positions of the nodes are calculated. For example, a joint of a multi-joint robot has only one rotational direction of the joint, and is constrained in two directions. A simulation of part deformation using the three dimensional finite element method only calculates the position of a node in consideration of this node. Consequently, when a joint position is calculated using the shape function as described in the aforementioned Japanese Patent Application Laid-Open No. H6-34012, only the joint position is obtained. However, no constraint is set in a rotational direction. There is thus a problem in that the calculation scheme of Japanese Patent Application Laid-Open No. H6-34012 is effective only in the case of a spherical joint.

Furthermore, it can be considered that in a simulation of part deformation using the three dimensional finite element method, a node of a mesh element corresponding to a joint position (i.e., junction point) and nodes around the node are fixed. This fixation can prevent a force applied to the part from concentrating on one node, and also prevent the part from rotating in a direction other than the rotational direction of the joint. However, such partial fixation of a certain node prevents the fixed part from being deformed. The fixation causes a problem of reducing the analytical accuracy around the joint; that is, the accurate position of the multi-joint robot after part deformation cannot be obtained.

### SUMMARY OF THE INVENTION

To address the problem, the present invention has an object to provide a simulation method and a simulation apparatus that can calculate the orientation of a deformed part at an arbitrary point set to the part and thereby execute accurate analysis.

According to an aspect of the present invention, a simulation method causes a calculating apparatus to execute a simulation using a three dimensional finite element method, wherein the calculating apparatus executes: shape setting that sets a shape of a part; mesh setting that sets a mesh by setting a plurality of nodes on the part; position setting that sets a position and an orientation of the part; arbitrary point setting that sets an arbitrary point having an arbitrary position and orientation, on the part; subsidiary point setting that sets at least two subsidiary points at different positions in different directions, with respect to the arbitrary point; simulation condition setting that inputs a condition of the simulation; deformation calculating that applies the input condition of the simulation to the part to execute calculation of deforming the part; position calculating after deformation that calculates the position of the arbitrary point and the positions of the subsidiary points after deformation of the part; and calculating orientation at arbitrary point that calculates the orientation of the arbitrary point from the position of the arbitrary point and the positions of the subsidiary points after deformation of the part.

According to a further aspect of the present invention, a simulation apparatus comprises a calculating unit that executes a simulation using a three dimensional finite element method, wherein the calculating unit executes: a shape setting process that sets a shape of a part; a mesh setting process that sets a mesh by setting a plurality of nodes on the part; a position setting process that sets a position and an orientation of the part; an arbitrary point setting process that sets an arbitrary point having an arbitrary position and orientation, on the part; a subsidiary point setting process that sets at least two subsidiary points at different positions in different directions, with respect to the arbitrary point, on the part; a simulation condition setting process that sets a condition of the simulation; a deformation calculating process that applies the condition of the simulation to the part to execute calculation of deforming the part; a process of position calculating after deformation that calculates the position of the arbitrary point and the positions of the subsidiary points after deformation of the part; and a process of calculating the orientation at the arbitrary point that calculates the orientation of the arbitrary point from the position of the arbitrary point and the positions of the subsidiary points after deformation of the part.

According to the present invention, an arbitrary point and at least two subsidiary points are set before deformation of a part, the arbitrary point and at least two subsidiary points after deformation of the part are calculated, and the orientation of the arbitrary point can be calculated from these positions. Consequently, accurate analysis can be executed.

Further features of the present invention will become apparent from the following description of exemplary embodiments with reference to the attached drawings.

### BRIEF DESCRIPTION OF THE DRAWINGS

FIG. 1 is a block diagram illustrating a calculating apparatus that can execute this simulation.

FIG. 2 is a main flowchart illustrating each process of this simulation.

FIG. 3 is a sub-flowchart illustrating part setting processing.

FIG. 4 is a sub-flowchart illustrating mechanism setting processing.

FIG. 5 is a sub-flowchart illustrating simulation processing.

FIG. 6 is a diagram illustrating a part to be deformed by a simulation and an observation point in a first embodiment.

FIG. 7 is a diagram illustrating a state where nodes and meshes are set to a part in the first embodiment.

FIG. 8 is a diagram illustrating subsidiary points set before deformation in the first embodiment.

FIG. 9 is a diagram illustrating a mesh element corresponding to an observation point, and its nodes in the first embodiment.

FIG. 10 is a diagram illustrating the part after deformation, and the observation point and the subsidiary point in the first embodiment.

FIG. 11 is a diagram illustrating a multi-joint robot deformed in a simulation, junction points and an observation point in a second embodiment.

FIG. 12 is a diagram illustrating the parts constituting the multi-joint robot in the second embodiment.

### DESCRIPTION OF THE EMBODIMENTS

Preferred embodiments of the present invention will now be described in detail in accordance with the accompanying drawings.

### First Embodiment

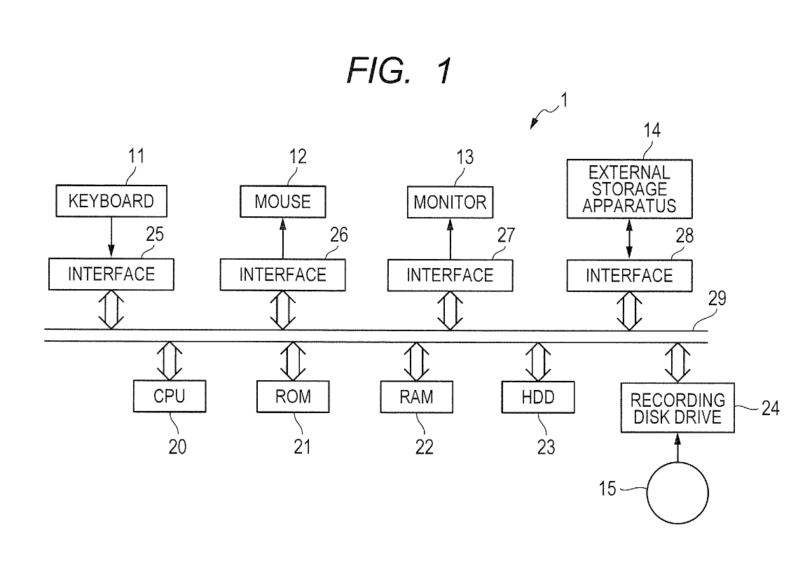

A first embodiment according to the present invention is hereinafter described with reference to FIGS. 1 to 10. First, an example of a calculating apparatus (computer system) that can execute a simulation that deforms parts according to this embodiment is described with reference to FIG. 1. FIG. 1 is a block diagram illustrating the calculating apparatus that can execute this simulation.

As illustrated in FIG. 1, the calculating apparatus 1, which functions as a simulation apparatus, includes: a CPU 20 serving as a calculating unit; a ROM 21, a RAM 22, a HDD 23 and a recording disk drive 24, which serve as storing media; and various types of interfaces 25, 26, 27 and 28. These ROM 21, RAM 22, HDD 23, recording disk drive 24 and various interfaces 25, 26, 27 and 28 are connected to the CPU 20 in a manner of allowing communication with each other via a bus 29.

The ROM 21 stores various programs for operating the CPU 20. The CPU 20 can execute a calculation process of a part deformation simulation, described later, based on the programs stored in the ROM 21. The RAM 22 is a storing unit for temporarily store processing results of the CPU 20. The HDD 23 is a storing device, and preliminarily stores various types of information, such as a part data and calculation expressions of the three dimensional finite element method. The HDD 23 stores a data including a calculation result by the CPU 20, under instruction of the CPU 20.

The calculating apparatus 1 further includes an operation and input unit, such as a key board 11 connected via the interface 25, and a mouse 12 connected via the interface 26, and can accept various types of operation and input. The calculating apparatus 1 further includes a monitor 13 connected via the interface 25, and can cause the monitor to display various screens, such as a data input (edit) screen and a display screen for displaying parts in a virtual three dimensional space. The interface 28 has a configuration where external storage apparatuses 14, such as a rewritable nonvolatile memory and an external HDD, can be connected. The recording disk drive 24 can read various data recorded in the recording disk 15, which is an example of the recording medium. The recording disk 15 can record and store programs that enable this simulation to be executed.

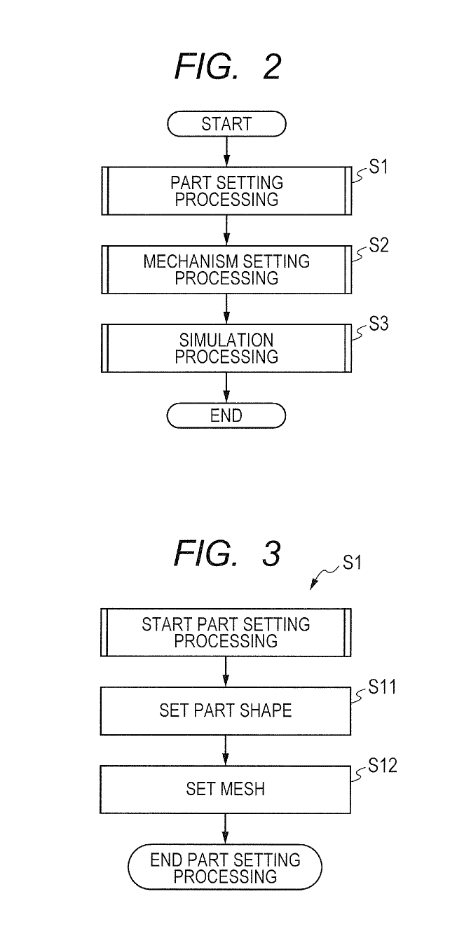

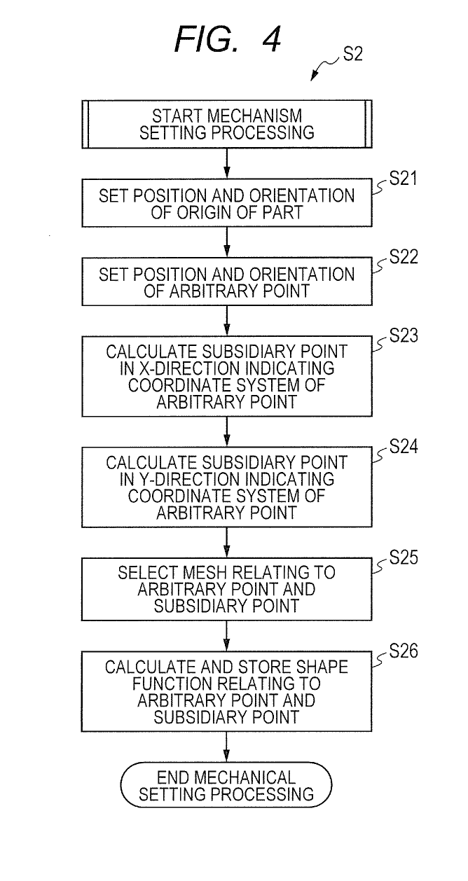

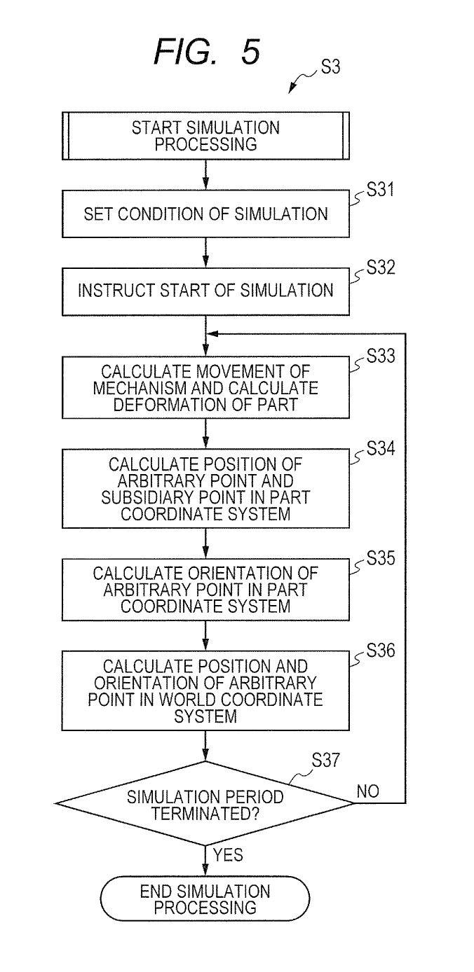

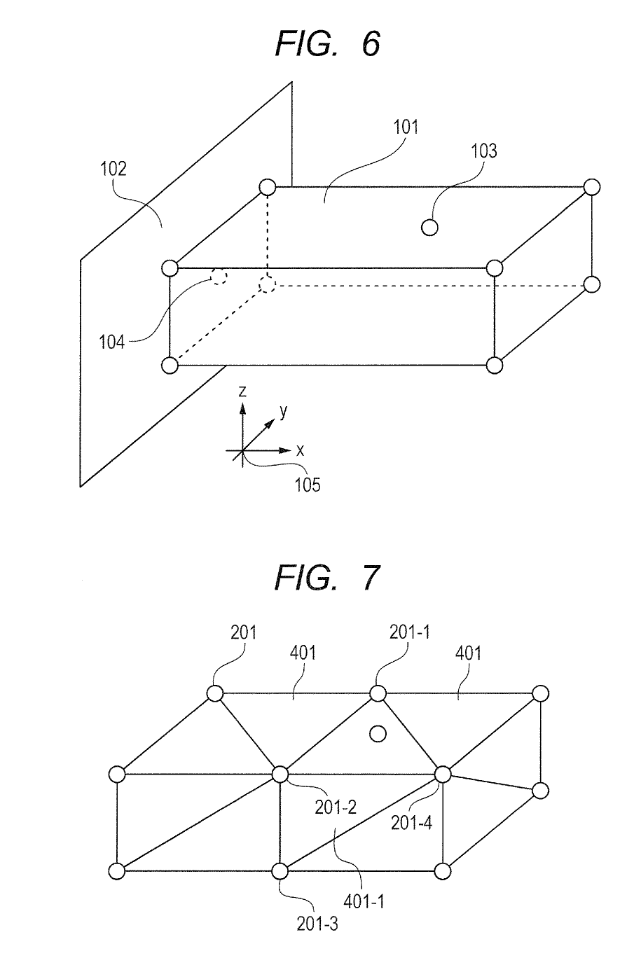

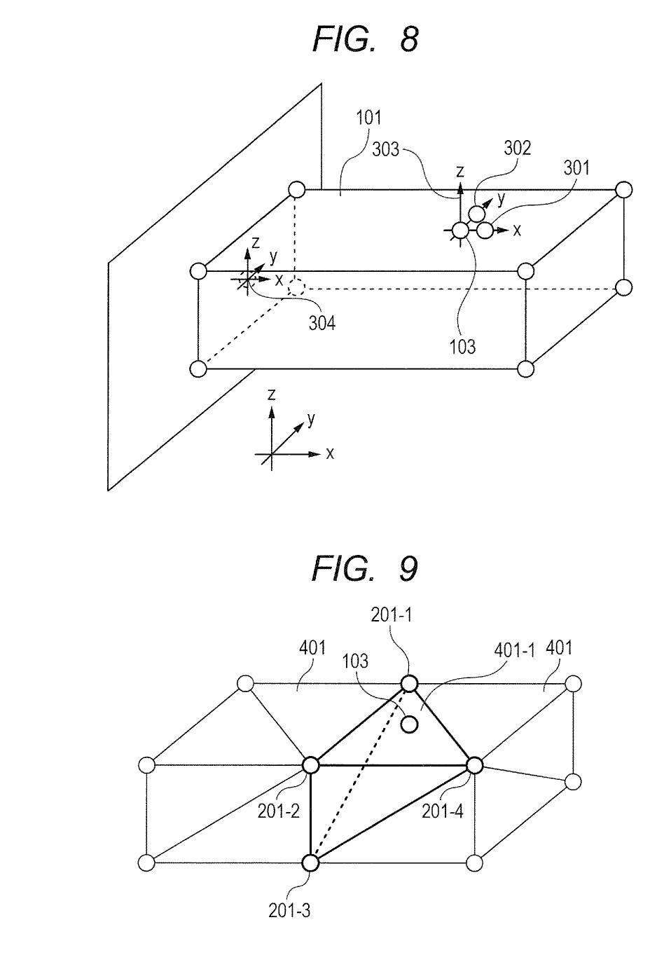

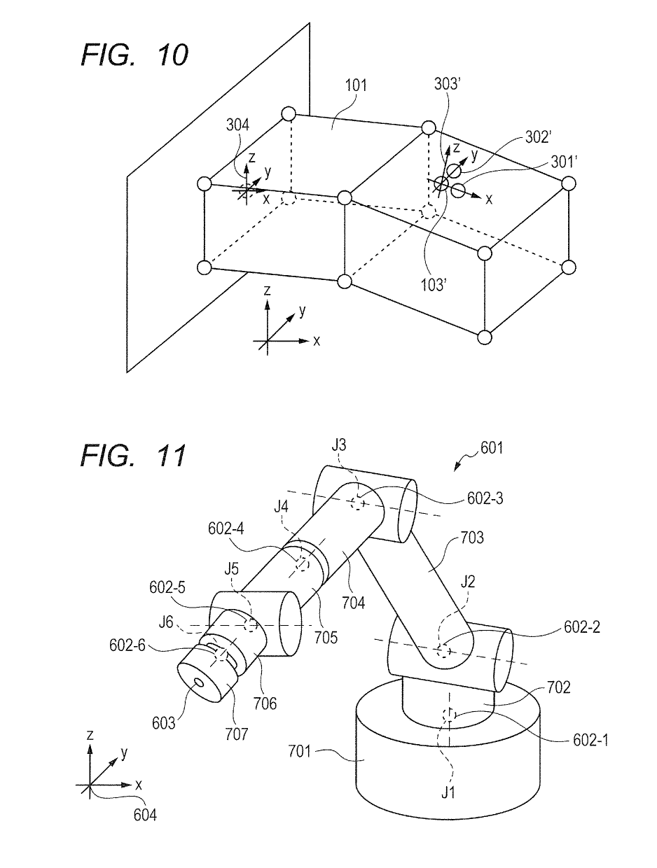

Subsequently, a simulation method according to this embodiment is described along with the process by the calculating apparatus 1. This first embodiment executes a simulation assuming that, for example, a part (camera attaching part) for fixing a monitoring camera (not illustrated) onto a wall surface is deformed by the weights of the monitoring camera and the part. This simulation is hereinafter described with reference to FIGS. 2 to 10. FIG. is a main flowchart illustrating each process in this simulation. FIG. 3 is a sub-flowchart illustrating part setting processing. FIG. 4 is a sub-flowchart illustrating mechanism setting processing. FIG. 5 is a sub-flowchart illustrating simulation processing. FIG. 6 is a diagram illustrating a part to be deformed by this simulation and an observation point. FIG. 7 is a diagram illustrating a state where nodes and meshes are set to a part. FIG. 8 illustrates subsidiary points set before deformation. FIG. 9 is a diagram illustrating a mesh element corresponding to the observation point, and its nodes. FIG. 10 is a diagram illustrating the part after deformation, and the observation point and the subsidiary point.

As illustrated in FIG. 2, after starting this simulation, the calculating apparatus 1 performs the part setting processing (S1), the mechanism setting processing (S2) and the simulation processing (S3). In the part setting processing (S1), as illustrated in FIG. 3, first, the calculating apparatus 1 sets a part shape (shape setting, shape setting process) (S11). That is, as illustrated in FIG. 6, the shape of a part 101 that is a camera attaching part is set in a virtual space, for example. The shape of the part 101 may be read from a data, such as of CAD, as part coordinates. Alternatively, the shape may be set by the user inputting the numerical values of part coordinates using the operation and input unit, such as the key board 11 or the mouse 12.

Subsequently, the calculating apparatus 1 sets a mesh (mesh setting, mesh setting process) (S12). As illustrated in FIG. 7, through setting of multiple nodes 201 on the part 101, which is a three dimensional continuous body, meshes 401 that are tetrahedral elements are set. In this state, each node 201 has position information in the part coordinate system. The mesh 401 has information on the nodes 201 that constitute the tetrahedral element. These pieces of information may be set using finite element method analysis software. Alternatively, the information may be freely set by the user using the operation and input unit, such as the key board 11 or the mouse 12. Thus, the part setting processing of step S1 in FIG. 2 is finished. The processing proceeds to the mechanism setting processing of step S2.

Next, after the processing advances to the mechanism setting processing (S2), as illustrated in FIG. 4, first, the calculating apparatus 1 sets the position and orientation of the part 101 on a wall surface 102 according to an operation and input by a user (position setting, position setting process) (S21). Not that in this embodiment, the origin of the wall surface 102 is set as that of a world coordinate system 105, as illustrated in FIG. 6. The origin of the coordinate system of the part 101 is set as that of translation of the world coordinate system 105. A part coordinate system 304 illustrated in FIG. 8 illustrates a coordinate system represented according to the orientation of the part 101 set by the user.

In the case of such setting of each coordinate system, the position and orientation of the origin 104 of the coordinate system of the part 101 in view of the world coordinate system 105 are represented in a homogeneous transformation matrix as follows.

$${Parts}_{4 \times 4} = [ \begin{matrix}1 & 0 & 0 & {x}_{p} \\ 0 & 1 & 0 & {y}_{p} \\ 0 & 0 & 1 & {z}_{p} \\ 0 & 0 & 0 & 1\end{matrix} ]$$

Next, according to an operation and input by the user, the calculating apparatus 1 sets, on the part 101, the position and orientation of an observation point (arbitrary point) 103 that can be designated by the user as an arbitrary position and orientation as a camera attaching point for attaching a monitoring camera (arbitrary point setting, arbitrary point setting process) (S22). In this embodiment, the point is an arbitrary point set to observe what position of the monitoring camera achieves what orientation after deformation of the part 101. Thus, this point is called “observation point 103”. Here, the user inputs information on the position and orientation of the observation point 103 for the part 101 before deformation. The calculating apparatus 1 then records, in the HDD 23, the input information on the position and orientation of the observation point 103 in the part coordinate system. Here, the direction of the observation point 103 is set assuming translation of the part coordinate system. An observation point coordinate system 303 illustrated in FIG. 8 indicates a coordinate system represented according to the orientation of the observation point 103.

In the case of thus setting the observation point 103, the position and orientation of the observation point 103 in view of the part coordinate system 304 are represented in a homogeneous transformation matrix as follows.

$${MeasuringPoint}_{4 \times 4} = [ \begin{matrix}1 & 0 & 0 & {x}_{m} \\ 0 & 1 & 0 & {y}_{m} \\ 0 & 0 & 1 & {z}_{m} \\ 0 & 0 & 0 & 1\end{matrix} ]$$

Subsequently, as illustrated in FIG. 8, the calculating apparatus 1 sets a x-direction subsidiary point 301 at a position slightly moved from the observation point 103 in the x-direction of the observation point coordinate system 303, and records the position in the HDD 23 (subsidiary point setting, subsidiary point setting process) (S23). Likewise, the calculating apparatus 1 sets a y-direction subsidiary point 302 at a position slightly moved from the observation point 103 in the y-direction of the observation point coordinate system 303, and records the position in the HDD 23 (subsidiary point setting, subsidiary point setting process) (S24). These subsidiary points are not limited to those in the x-direction and y-direction of the observation point coordinate system 303, but are required to be set on at least two independent different positions in different directions on the observation point. The observation point 103 and the two or more subsidiary points should not on a straight line. That is, any observation point 103 and two or more subsidiary points are allowed only if these points can define one plane.

Next, as illustrated in FIG. 9, the calculating apparatus 1 selects a mesh element 401-1 that includes the observation point 103 or disposed closest to this point in the part 101 to which the observation point 103 belongs (i.e., the mesh element corresponding to the arbitrary point) (S25). The apparatus then calculates a shape function that is a relational expression that represents the relationship between the displacement of the observation point 103 and the displacements of the nodes 201-1 to 201-4 constituting the mesh element 401-1 when the part 101 deforms, and stores the information on the mesh element 401-1 and the shape function in the HDD 23 (S27).

This shape function is a typical one. Consequently, description on deriving this shape function is omitted. The relationship of the displacements of the four nodes 201-1 to 201-4 and the observation point 103 can be represented as follows. Here, the first term of the left-hand side represents the displacement of the observation point 103. The first term of the right-hand side represents the shape function corresponding to the observation point 103. The second term of the right-hand side represents the amount of displacements of the nodes 201-1 to 201-4 that constitute the mesh element 401-1 to which the observation point 103 belongs.

$$[ Δ x Δ y Δ z ] = [ {N}_{1} {N}_{2} {N}_{3} {N}_{4} ] [ \begin{matrix}Δ {x}_{1} & Δ {y}_{1} & Δ {z}_{1} \\ Δ {x}_{2} & Δ {y}_{2} & Δ {z}_{2} \\ Δ {x}_{3} & Δ {y}_{3} & Δ {z}_{3} \\ Δ {x}_{4} & Δ {y}_{4} & Δ {z}_{4}\end{matrix} ] \qquad ( 1 )$$

In this step S26, likewise also on the x-direction subsidiary point 301 and the y-direction subsidiary point 302, information on the corresponding mesh element 401-1 and the shape function are stored in the HDD 23. Any function may be adopted as the shape function only if the function is of a relational expression that can calculate the positional relationship or displacement relationship between the observation point or subsidiary point and the mesh element or its nodes. The mechanism setting processing of step S2 is thus finished.

Next, the simulation processing (S3) is described with reference to FIG. 5. First, the user operates the operation and input unit, such as the key board 11 or the mouse 12 to set the condition of the simulation that includes external forces, such as a torque required for the rotation of a part and the gravitation, and the simulation time, in the calculating apparatus 1 (simulation condition setting, simulation condition setting process) (S31).

Subsequently, the user inputs a simulation start instruction through the operation and input unit, thereby allowing the calculating apparatus 1 to start executing the simulation of deforming the part (S32). The calculating apparatus 1 then calculates the deformation of the part according to the condition of simulation set by the user (deformation calculating, deformation calculating process) (S33). FIG. 10 illustrates a simulation result after the part 101 has been deformed (after deformation). The part 101 has been deformed by the external forces set by the user and the gravitation applied to the entire part. The amount of displacements of all the nodes 201 set on the part 101 is updated accordingly.

Next, the calculating apparatus 1 calculates the position of the observation point 103′, the x-direction subsidiary point 301′ and the y-direction subsidiary point 302′ after deformation of the part 101 in the part coordinate system (position calculating after deformation, a process of position calculating after deformation) (S34). That is, first, the calculating apparatus 1 calculates the amount of change of the observation point 103′ using the Expression (1). That is, as to Expression (1), the shape function that has been stored in the previous stage and corresponds to the observation point 103 is substituted in the first term of the right-hand side, and the amounts of displacements of the nodes 201-1 to 201-4 constituting the mesh element 401-1 corresponding to the observation point 103 is substituted in the second term of the right-hand side. The displacement of the observation point 103′ after deformation of the part 101 represented by the left-hand side can thus be calculated. Likewise, the amounts of displacements of the x-direction subsidiary point 301′ and the y-direction subsidiary point 302′ after deformation of the part 101 can also be calculated from the Expression (1) using the shape function.

Next, the position of the observation point 103′ after deformation of the part 101 in the part coordinate system 304 is calculated. The position of the observation point 103 in the part coordinate system 304 before deformation of the part 101 is stored in step S22 described above. Consequently, the position in the part coordinate system 304 can be calculated by simply adding the amounts of change. Thus, the position of the observation point 103′ after deformation of the part 101 is represented in the part coordinate system 304 as follows.

MeasuringPoint_{local}=[xₘ+Δxₘ yₘ+Δyₘ, zₘ+Δzₘ] (2)

Likewise, the positions of the x-direction subsidiary point 301′ and the y-direction subsidiary point 302′ after deformation of the part 101 are represented in the part coordinate system 304 as follows.

MeasuringPointₓ_{_}_{local}=[xₘₓ+Δxₙₓ yₘₓ+Δyₙₓ zₘₓ+Δzₘₓ]

MeasuringPoint_{y}_{_}_{local}=[x_{my}+Δx_{ny} y_{my}+Δy_{ny} z_{my}+Δz_{my}] (3)

Next, the calculating apparatus 1 calculates the orientation of the observation point 103′ in the part coordinate system 304 (S35). Here, the observation point coordinate system 303′ of the observation point 103′ after deformation of the part 101 is required to be represented using the x-direction subsidiary point 301′ and the y-direction subsidiary point 302′. However, in consideration of two vectors from the observation point 103′ to the x-direction subsidiary point 301′ and the y-direction subsidiary point 302′, these vectors are not necessarily in an orthogonal state. This is because of the displacements of the subsidiary points owing to the deformation of the part 101.

The z-direction in the observation point coordinate system 303′ is orthogonal to the XY-plane on which the observation point 103′, the x-direction subsidiary point 301′ and the y-direction subsidiary point 302′ are positioned. Consequently, the z-direction in the observation point coordinate system 303′ can be determined based on the vector representing the direction to the x-direction subsidiary point 301′ and the vector representing the direction to the y-direction subsidiary point 302′. When the direction to the x-direction subsidiary point 301′ is the x-direction, the x-direction and the z-direction are determined, thereby allowing the y-direction to be determined.

That is, unit vectors of the observation point coordinate system 303′ for representing the orientation of the observation point 103′ after deformation of the part 101 can be calculated from the results of calculations of the Expression (2) and the Expression (3) as follows.

Z=normalize((MPₓ_{_}_{local}−MP_{local})×(MP_{y}_{_}_{local}−MP_{local}))=[x_{mz}_{_}ₙ y_{mz}_{_}ₙ z_{mz}_{_}ₙ]

X=normalize(MPₓ_{_}_{local}−MP_{local})=[xₘₓ_{_}ₙ yₘₓ_{_}ₙ zₘₓ_{_}ₙ]

Y=Z×X=[x_{my}_{_}ₙ y_{my}_{_}ₙ z_{my}_{_}ₙ]

Thus, the position and orientation of the observation point 103′ in the part coordinate system 304′ after deformation of the part 101 can be determined. Here, the method of calculating the unit vectors of the observation point coordinate system 303′ is represented as an example. The method is not limited to this example. Alternatively, the y-direction vector may be calculated after calculation of the z-direction vector, for example.

The calculating apparatus 1 calculates the position and orientation of the observation point 103′ in the world coordinate system 105 (calculating orientation at arbitrary point, a process of calculating orientation at arbitrary point) (S36). That is, in consideration of the movement of the observation point 103′ due to the deformation of the part 101, the position and orientation of the observation point 103 in the world coordinate system 105 are calculated. The homogeneous transformation matrix that represents the position and orientation of the observation point 103′ in the world coordinate system 105 can be calculated based on the homogeneous transformation matrix that represents the position and orientation of the part coordinate system 304 in the world coordinate system 105 and the position and orientation of the observation point 103′ after deformation in the part coordinate system 304.

$${MeasuringPoint}_{4 \times {4}_{—} world} = [ \begin{matrix}1 & 0 & 0 & {x}_{p} \\ 0 & 1 & 0 & {y}_{p} \\ 0 & 0 & 1 & {z}_{p} \\ 0 & 0 & 0 & 1\end{matrix} ] [ \begin{matrix}{x}_{{mx}_{—} m} & {x}_{{my}_{—} n} & {x}_{{mz}_{—} n} & {x}_{m} \\ {y}_{{mx}_{—} n} & {y}_{{my}_{—} n} & {y}_{{mz}_{—} n} & {y}_{m} \\ {z}_{{mx}_{—} n} & {z}_{{my}_{—} n} & {z}_{{mz}_{—} n} & {z}_{m} \\ 0 & 0 & 0 & 1\end{matrix} ] \qquad ( 4 )$$

In the Expression (4), the first term of the right-hand side is the homogeneous transformation matrix that represents the position and orientation of the part coordinate system 304 in the world coordinate system 105, and the second term of the right-hand side is the homogeneous transformation matrix that represents the position and orientation of the observation point 103′ in consideration of the part deformation in the part coordinate system 304.

As described above, in the deformation of the part 101 fixed on the wall surface 102, it can be calculated how the position and orientation is changed in the world coordinate system 105 between the observation point 103 before deformation and the observation point 103′ after deformation.

Finally, the calculating apparatus 1 confirms whether the simulation time set in step S31 has elapsed or not. If the time has not elapsed, the processing returns to step S33 and the simulation is continued (NO in S37). If the time has elapsed, the simulation is finished (YES in S37). All the processes of the simulation in this embodiment are thus finished.

As described above, the simulation method according to this first embodiment can calculate the orientation of the observation point 103, which is the arbitrary point whose position and orientation have been freely set, after deformation of the part 101, using at least two subsidiary points.

For example, this first embodiment can perform analysis of the deformation of the part 101, which is the camera attaching part in the case of fixing the monitoring camera on the wall surface 102. The part 101 is deformed by the weights of the camera and the part 101, and the position of the observation point 103, which is the camera attachment position on the part 101, and its orientation are changed accordingly. Consequently, it can be calculated how the design of the part 101 inclines the visual line of the camera downward, and the calculation can be applied the problem whether the visual line of the camera can be accommodated in a permissible value or not.

Furthermore, according to the simulation method of this first embodiment, the node of the mesh element corresponding to the observation point and the nodes around the node is not fixed for calculating the orientation of the camera attachment position. Consequently, the method can accurately perform the simulation.

Moreover, the simulation method according to the first embodiment newly resets the observation point at the new camera attachment position when the camera attachment position is changed with respect to the same part. Consequently, the position and orientation with respect to the new camera attachment position after deformation can be easily analyzed. That is, setting the observation point as the new node, in turn, resets the new mesh on the part. In this case, the mesh setting process of step S12 is performed again, and the calculation of the matrix presenting physical characteristics or feature of a mesh required for the calculation of the three dimensional finite element method is performed again. Consequently, there is a possibility of increasing the time in some cases of the calculation process speed and the scale of mesh. However, in this first embodiment, the position of the observation point is defined using the shape function for the node of the mesh element corresponding to the observation point. Consequently, the necessity of changing the setting of the mesh and node for the part can be eliminated. The positions of the observation point and the subsidiary point can therefore be changed and reset. The calculation of deforming the part using the matrix calculated in the mesh setting process before resetting the observation point can be executed without recalculating the matrix required for the calculation of the three dimensional finite element method. Consequently, the observation point can be easily changed (or added) without lapse of a long time. That is, the camera attachment position is newly and easily changed, for example.

In this embodiment, the description has been made only for the case where the position of the observation point is set for the node of the mesh element using the shape function. It is a matter of course that if the mesh setting process of step S12 is allowed to be performed again, the observation point and the subsidiary points may be set as the nodes. More specifically, when the position of the observation point is set, the observation point is set as a new node and the positions of the subsidiary points are set as new nodes in the same manner. When the position of the observation point and the positions of the subsidiary points after deformation of the part are calculated, the positions of the nodes that are to be the observation point and the subsidiary points are obtained from the positions of the calculated nodes, thereby calculating the position of the observation point and the subsidiary points. After successful calculation of the position of the observation point and the positions of the subsidiary points, the coordinate system is calculated from the directions of the two vectors in the same manner. This calculation allows calculation in the world coordinate system, which allows the orientation of the observation point to be obtained.

### Second Embodiment

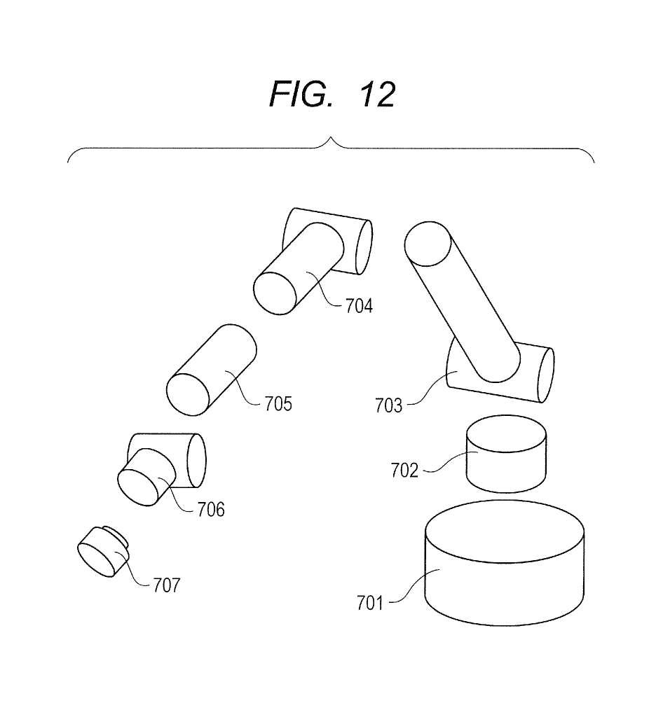

Subsequently, a second embodiment partially changed from the first embodiment is described with reference to FIGS. 11 and 12. FIG. 11 is a diagram illustrating a multi-joint robot deformed in a simulation, junction points and an observation point. FIG. 12 is a diagram illustrating the parts that constitute the multi-joint robot.

In this second embodiment, the target of simulation is changed from the camera attaching member to a multi-joint robot that includes multiple joints, compared to the first embodiment. The simulation method (calculation process) according to this second embodiment itself is substantially identical to that of the first embodiment. In the multi-joint robot, multiple parts (frames) each have a relationship of being joined by a rotational joint in a manner movable in the rotational direction about one axis. The orientation of the junction point indicating a junction portion between frames exerts an effect on the position of the next part. Consequently, this second embodiment sets the junction point as an arbitrary point on each joint, and analyzes the orientation of the junction point. When the multi-joint robot is driven by driving each joint, it is analyzed how the distal end of a hand (distal end) of the multi-joint robot is moved, thereby allowing, for example, the straightness in movement of the distal end of the hand to be verified. Thus, this second embodiment sets the observation point as an arbitrary point on the distal end of the hand of the multi-joint robot, and also analyzes the orientation of the observation point. Hereinafter, the simulation method according to this second embodiment is specifically described with reference to the flowcharts of FIGS. 2 to 5 and schematic diagrams of the multi-joint robot shown in FIGS. 11 and 12.

As shown in FIG. 11, in the multi-joint robot 601, a robot part 702 serving as a frame is joined through a joint J1 to a base part 701 serving as a base stage. Furthermore, a robot part 703 serving as a frame is jointed through a joint J2 to the robot part 702. A robot part 704 serving as a frame is jointed through a joint J3 to the robot part 703. Moreover, a robot part 705 serving as a frame is jointed through a joint J4 to the robot part 704. A robot part 706 serving as a frame is jointed through a joint J5 to the robot part 705. Furthermore, a robot part 707 serving as an end effector is joined through joint J6 to the robot part 706. The distal end of the robot part 707 serves as the distal end of the hand to which a robot hand is attached, for example.

After starting this simulation, first, the calculating apparatus 1 executes the part setting processing (S1). As shown in FIG. 3, the user sets the shapes of the base part 701 and robot parts 702 to 707 that are to be used in the simulation (S11), and also sets mesh elements that form three dimensional elements (tetrahedrons, pentahedrons, and hexahedrons) and nodes (S12). The mesh setting is analogous to that in the first embodiment.

Next, the calculating apparatus 1 executes the mechanism setting processing (S2). In step S21, the user sets the position and orientation of the origin of the coordinate system for the base part 701 and the robot parts 702 to 707, thus setting the multi-joint robot 601 having the multiple joints J1 to J6. First, the position and orientation of the base part 701 in the world coordinate system 604 are set. Next, the position and orientation of the robot part 702 set on the base part 701 are set in the coordinate system of the base part 701. Subsequently, the positions and orientations of the robot parts 703 to 707 are sequentially set.

Next, in step S22, a junction point 602-1 that is an arbitrary point is set on the joint J1 that connects the base part 701 and the robot part 702 to each other, and stored. For simplicity, the position and orientation of the junction point 602-1 are assumed to coincide with the position and orientation of the origin of the robot part 702. Subsequently, junction points 602-2 to 602-6 are sequentially set on the respective joints J2 to J6 of the robot parts 703 to 707, and stored. Furthermore, the user sets an observation point that is an arbitrary point on the distal end of a hand of the multi-joint robot 601. That is, the observation point 603 is set on the robot part 707. That is, the user inputs, into the simulation system, information on the position and orientation of the observation point 603 in the coordinate system of the robot part 707. The calculating apparatus 1 stores the input information on the position and orientation of the observation point 603 in the coordinate system of the part 707. Here, the coordinate system of the observation point 603 is assumed to be translation of the coordinate system of the robot part 707.

Subsequently, in step S23, the calculating apparatus 1 sets an x-direction subsidiary point at a position slightly moved in the x-direction in the coordinate system of the junction points 602-1 to 602-6, and the position is stored. Furthermore, the calculating apparatus 1 sets an x-direction subsidiary point at a position slightly moved in the x-direction in the coordinate system of the observation point 603, and the position is stored.

Furthermore, in step S24, the calculating apparatus 1 sets a y-direction subsidiary point at a position slightly moved in the y-direction in the coordinate system of the junction points 602-1 to 602-6, and the position is stored. Moreover, the calculating apparatus 1 sets a y-direction subsidiary point at a position slightly moved in the y-direction in the coordinate system of the observation point 603, and the position is stored.

These subsidiary points are not limited to the cases of setting in the x-direction and y-direction in the coordinate system set by the user. However, as described in the first embodiment, these points are required to have different directional components in view from the junction point or the observation point.

Next, in step S26, first, the calculating apparatus 1 selects a mesh element closest to the junction point 602-1 in the base part 701 and the robot part 702 constrained by the joint J1. Next, the shape function that represents the relationship between the displacement of the junction point 602-1 and the displacements of the nodes constituting the mesh element is calculated, and information on the mesh element and the shape function are stored. Likewise, information on the mesh element and the shape function for the x-direction subsidiary point and the y-direction subsidiary point of the junction point 602-1 are stored. Likewise, information on the closest mesh element and the shape function for the x-direction subsidiary point and the y-direction subsidiary point of each of the junction points 602-2 to 602-6 are stored. Furthermore, the calculating apparatus 1 selects a mesh element closest to the observation point 603 in the part 707 to which the observation point 603 belongs. Next, the shape function that represents the relationship between the displacement of the observation point 603 and the displacements of the nodes constituting the mesh element is calculated, and information on the mesh element and the shape function is stored.

In this second embodiment, the mesh element for calculation of the shape function is called the mesh element closest to the junction point or the observation point, because the junction point is not necessarily set on the part. That is, as the junction points are set on the shafts of the respective joints, the junction points are positioned on the shaft members constituting the shafts of the joints, in a strict view. However, if the simulation is performed even for the shaft members, the amount of calculation is significantly increased. Consequently, the junction point may sometimes be set on a position slightly apart from the part. Likewise, the observation point is positioned on the robot hand. Unfortunately, the simulation even for finger members significantly increases the amount of calculation. Consequently, the observation point may sometimes be set on a position slightly apart from the part. Thus, in this embodiment, the representation “the mesh element closest to the junction point or the observation point” is used. However, it is only required that a mesh element corresponding to the junction point or the observation point can be set. These junction point or observation point may be set in the corresponding mesh element or on the surface of this element.

Next, the calculating apparatus 1 executes the simulation processing (S3). First, the user sets the condition of simulation (S31). For example, conditions are set that include external forces, such as torques applied to the joints J1 to J6 of the multi-joint robot 601 and the gravitation, and the simulation time.

Next, the user inputs an instruction of start of the simulation into the calculating apparatus 1 (S32). The calculating apparatus 1 calculates the movement in consideration of the dynamics of the mechanism, and the deformation of the part, according to the condition of simulation set by the user (S33). Next, the calculating apparatus 1 calculates the positions of the junction points 602-1 to 602-6, the observation point 603, and the subsidiary points after deformation of the part (S34). The calculating apparatus 1 then calculates the positions and orientations of the junction points 602-1 to 602-6 and the observation point 603 in the part coordinate system (S35), and further calculates the position and orientation of the junction points 602-1 to 602-6 and the observation point 603 in the world coordinate system (S36).

In the mechanism including the multiple joints J1 to J6 such as the multi-joint robot 601 shown in FIG. 11, a slight deformation of each of the parts 701 to 707 largely affects the position and orientation of the observation point 603. The parts 701 to 707 are deformed by the torques applied to joints J1 to J6 and the gravitation applied to all the parts 701 to 707. Upon the deformation of the parts 701 to 707, the amounts of displacements of nodes set to the parts are updated. The position and orientation of the junction points 602-1 to 602-6 that join the parts 701 to 707 are displaced accordingly. The calculating apparatus 1 therefore calculates the positions and orientations of the junction points 602-1 to 602-6 and the observation point 603 in consideration of the deformation. In such a simulation of the multi-joint robot 601, the calculation scheme is basically the same as that of the first embodiment except the fact that the part deformation on the proximal side, i.e., the side of the base part 701, cumulatively affects the position and orientation on the side of the distal end of the hand. Consequently, the description of the calculation expression is omitted.

Finally, the calculating apparatus 1 confirms whether the simulation time set in step S31 has elapsed or not. If the time has not elapsed (NO in S37), the processing returns to step S33 and the simulation is continued. If the time has elapsed (YES in S37), the simulation is finished. All the processes of the simulation are thus finished.

According to the second embodiment described above, for example, when a tool such as a driver or a tweezers is held by the robot hand attached to the multi-joint robot 601, the position and orientation of the distal end of the tool can be confirmed by the simulation.

That is, when the multi-joint robot 601 has a certain orientation, the base part 701 and the robot parts 702 to 707 are deformed by the weights of the base part 701, robot parts 702 to 707 and the tool fixed to the robot part 707. The position and orientation of the distal end of the hand of the multi-joint robot 601 is changed accordingly. In particular, in a case of a long tool, the orientation of the distal end of the hand of the multi-joint robot 601 largely affects the position and orientation of the distal end of the tool. As with this embodiment, the observation point 603 is set on the distal end of the hand of the multi-joint robot 601, and the position and orientation are analyzed. The analysis can be used to solve the problems of obtaining a design of the base part 701 and the robot parts 702 to 707 that can reduce variation in orientation of the distal end of the hand, and a driving control of the orientation of the multi-joint robot 601 that can perform an accurate operation.

Also in the second embodiment, the nodes of the mesh element that correspond to the junction points 602-1 to 602-6 and the observation point 603 and the nodes therearound are not fixed. Consequently, the method can accurately perform the simulation.

It may be assumed that there is a tool fixed to the multi-joint robot 601, and the observation point may be set at the tool to thereby analyze the position and orientation of the tool. In this case, use of the shape function as the method of representing the observation point can add the observation point without changing the mesh and the nodes of the part 707. Consequently, the mesh setting S12 is not required to be performed again.

Furthermore, in the case of replacing the robot part 707 with a part having a joint, the simulation can be executed in an analogous manner by changing the position and orientation of the joint included in the robot part 707 assuming that the robot part 707 has the joint. In this case, use of the shape function as the new method of representing the joint position can set a new position and orientation of the joint without changing the mesh and the nodes of the robot part 707. Consequently, the mesh setting S12 is not required to be performed again.

As to the multi-joint robot simulated as described above, the multi-joint robot is designed using the result of the simulation, and the designed multi-joint robot is manufactured, which can obtain the multi-joint robot that can accurately control the orientation. Parts and assemblies manufactured by such a multi-joint robot also become accurate, which improves yields in manufacturing.

In the first and second embodiments described above, the description has been made assuming that the mesh element used in the three dimensional finite element method is a tetrahedron. The element is not limited to this example. Alternatively, mesh elements, such as a pentahedron and a hexahedron, may be used.

In the first and the second embodiments described above, the cases of simulating the camera attaching part and the multi-joint robot have been described. The application is not limited to these examples. Any target of analysis of the position and orientation of an object whose orientation is changed by deformation of a part can be analyzed. For example, the technique is applicable also to analysis in the case where when a connector is gripped by a gripper, the connector is deformed and the direction (orientation) of the distal end of the connector is changed. Furthermore, it is a matter of course that the technique is applicable not only to the multi-joint robot but also to a robot that has a joint that allows multiple frames to be moved.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-133451, filed Jul. 2, 2015, which is hereby incorporated by reference herein in its entirety.

What is claimed is:

1. A simulation method causing a calculating apparatus to execute a simulation using a three dimensional finite element method,
wherein the calculating apparatus executes:
shape setting that sets a shape of a part;
mesh setting that sets a mesh by setting a plurality of nodes on the part;
position setting that sets a position and an orientation of the part;
arbitrary point setting that sets an arbitrary point having an arbitrary position and orientation, on the part;
subsidiary point setting that sets at least two subsidiary points at different positions in different directions, with respect to the arbitrary point;
simulation condition setting that inputs a condition of the simulation;
deformation calculating that applies the input condition of the simulation to the part to execute calculation of deforming the part;
position calculating after deformation that calculates the position of the arbitrary point and the positions of the subsidiary points after deformation of the part; and
calculating orientation at arbitrary point that calculates the orientation of the arbitrary point from the position of the arbitrary point and the positions of the subsidiary points after deformation of the part.

2. The simulation method according to claim 1,
wherein the calculating apparatus stores the position of the arbitrary point as a relational expression with the node in one mesh element of the mesh, when setting the position of the arbitrary point in the arbitrary point setting,
stores the positions of the subsidiary points as a relational expression with the node in the one mesh element, when setting the positions of the subsidiary points in the subsidiary point setting, and
calculates the position of the arbitrary point and the positions of the subsidiary points after deformation of the part from the relational expressions stored in the arbitrary point setting and the subsidiary point setting, and the position of the node in the one mesh element when calculating the position of the arbitrary point and the positions of the subsidiary points after deformation of the part in the position calculating after deformation.

3. The simulation method according to claim 2,
wherein the relational expressions stored in the arbitrary point setting and the subsidiary point setting are shape functions.

4. The simulation method according to claim 2,
wherein, when setting the mesh in the mesh setting, the calculating apparatus calculates a matrix representing physical characteristics or feature of the mesh,
can change and reset the position and orientation of the arbitrary point and the positions of the subsidiary points in the arbitrary point setting and the subsidiary point setting, and
in performing the calculation of deforming the part in the deformation calculating after resetting the arbitrary point and the subsidiary points in the arbitrary point setting and the subsidiary point setting, executes the calculation using the matrix calculated in the mesh setting before resetting the arbitrary point and the subsidiary points.

5. The simulation method according to claim 1,
wherein the calculating apparatus sets the arbitrary point as a new node when setting the position of the arbitrary point in the arbitrary point setting,
sets the subsidiary points as new nodes when setting the positions of the subsidiary points in the subsidiary point setting, and
calculates the position of the arbitrary point and the positions of the subsidiary points by obtaining the positions of the nodes serving as the arbitrary point and the subsidiary points from the position of the nodes calculated in the deformation calculating when calculating the position of the arbitrary point and the positions of the subsidiary points after deformation of the part in the position calculating after deformation.

6. The simulation method according to claim 1,
wherein the part is a robot that includes a joint allowing a plurality of frames to be moved,
the arbitrary point is a junction point representing a junction portion between the frames at the joint and/or an observation point for observing the a position and an orientation of a distal end of a hand of the robot, and
when the robot is driven, the positions and orientations of the junction point at the joint and/or the observation point at the distal end of the hand are simulated.

7. A program causing a calculating apparatus to execute the simulation method according to claim 1.

8. A non-transitory computer-readable recording medium storing the program according to claim 7.

9. A method of manufacturing a robot comprising:
simulating a robot executed by the simulation method according to claim 6;
designing the robot using a result of the simulating; and
manufacturing the robot based on the designing.

10. A method of manufacturing a part using a robot manufactured by the method of manufacturing a robot according to claim 9.

11. A simulation apparatus comprising a calculating unit that executes a simulation using a three dimensional finite element method,
wherein the calculating unit executes:
a shape setting process that sets a shape of a part;
a mesh setting process that sets a mesh by setting a plurality of nodes on the part;
a position setting process that sets a position and an orientation of the part;
an arbitrary point setting process that sets an arbitrary point having an arbitrary position and orientation, on the part;
a subsidiary point setting process that sets at least two subsidiary points at different positions in different directions, with respect to the arbitrary point, on the part;
a simulation condition setting process that sets a condition of the simulation;
a deformation calculating process that applies the condition of the simulation to the part to execute calculation of deforming the part;
a process of position calculating after deformation that calculates the position of the arbitrary point and the positions of the subsidiary points after deformation of the part; and
a process of calculating the orientation at the arbitrary point that calculates the orientation of the arbitrary point from the position of the arbitrary point and the positions of the subsidiary points after deformation of the part.
